(19) United States
(12) Patent Application Publication
(10) Pub. No.: US 2007/0040401 A1
(43) Pub. Date: Feb. 22, 2007

(54) REMOTE LOCKING ASSEMBLY

(76) Inventor: Ronald E. POOLE, Albany, GA (US)

Correspondence Address: GARDNER GROFF SANTOS & GREENWALD, P.C., 2018 POWERS FERRY ROAD, SUITE 800, ATLANTA, GA, 30339, US

(21) Appl. No.: 11/460,353

(22) Filed: Jul. 27, 2006

Related U.S. Application Data
(60) Provisional application No. 60/709,133, filed on Aug. 17, 2005.

(51) Int. Cl. B60R 9/06

(52) U.S. Cl. 296/37.6

(57) ABSTRACT

A remote locking assembly suitable for use with toolboxes mounted within a cargo area of a vehicle. The remote locking assembly of the present invention includes an electronically controlled actuator, a locking member, a latching member, a support bracket, and a handle.

### CROSS-REFERENCE TO RELATED APPLICATION

This application claims the benefit of U.S. Provisional Patent Application Ser. No. 60/709,133, filed Aug. 17, 2005, which application is incorporated herein by reference in its entirety for all purposes.

### TECHNICAL FIELD

The present invention relates generally to the field of vehicle-mounted storage boxes and more particularly to a remote locking assembly for truck-mounted tool boxes.

### BACKGROUND OF THE INVENTION

Toolboxes that are mounted in the cargo area of vehicles are well known in the art. These toolboxes may be attached directly behind the cab of a vehicle such as in the bed of a pickup truck as seen in FIG. 1. These toolboxes may also be mounted along the interior sides of the cargo area of vehicles and allow vehicle users to carry tools and other items for work or recreation. Often times these toolboxes are used to store valuable items such as tools and recreation equipment. Therefore, it is important that these toolboxes are capable of being locked. Traditionally, these toolboxes are locked with a manual key lock or padlock or some other manual external locking device.

Many of the vehicles today that are capable of being mounted with a storage toolbox have electronic locking systems for locking and unlocking the vehicles' doors. Moreover, a large percentage of these vehicles have remote locking systems that permit users to electronically lock and unlock the doors of the vehicles using a handheld keyfob or other type of transmitter device. Remote locking systems have therefore enabled users to lock and unlock a vehicle's doors from a substantial distance away from the vehicle. However, vehicle-mounted toolboxes are usually added to a vehicle as an aftermarket add-on and, as such, are typically locked/unlocked by a user with a manual key lock mechanism despite the fact that the vehicle itself may be equipped with an electronic/remote locking system.

Typically, traditional key lock means for locking a toolbox require the user or operator of the vehicle to carry an extra key or locking mechanism to secure the toolbox and require that the user remember to lock the toolbox after use. A user may carry an abundance of keys and it can be difficult to remember which key locks/unlocks the storage toolbox. Additionally, a user must be proximal the toolbox in order to lock and secure the same. This may not always be practical when, for instance, a user wishes to continuously lock and unlock the toolbox at a construction site to allow/deny access to other people at the site. It is inconvenient for a user to constantly walk back and forth from the vehicle to lock and unlock the toolbox.

Accordingly, it can be seen that needs exist in the art for a remote locking device for locking a vehicle cargo area toolbox and one that may be controlled by the vehicle's internal electric locking system. It is to the provision of a locking system for a vehicle-mounted container meeting these and other needs that the present invention is primarily directed.

### SUMMARY OF THE INVENTION

In example embodiments, the present invention provides a locking system for vehicle-mounted toolboxes, and an improved toolbox or other container including such a locking system. The ability to remotely lock and unlock a toolbox, as well as the linking of operation of the toolbox locking system with the vehicle's door-locking system greatly enhances user convenience, efficiency and security.

In one aspect, the present invention is a locking assembly for a vehicle-mounted toolbox having a body and a lid. The locking assembly includes a latching member for selectively latching and releasing the toolbox lid and the toolbox body. The assembly also includes an electronically controlled actuator and a locking member. The locking member is movable between a first position and a second position by operation of the electronically controlled actuator, wherein the locking member engages the latching member in the first position and disengages the latching member in the second position. Optionally, the latching member is rotationally mounted to the toolbox and able to rotate between a latched position preventing the opening of the lid, and a released position permitting opening of the lid.

In another aspect, the invention is a storage container for mounting to a vehicle. The storage container includes a container body enclosing a storage compartment and defining an opening for access to the storage compartment. The container also includes a lid and a locking assembly. The lid selectively covers and uncovers the opening in the storage compartment to prevent and permit access to the storage compartment. The locking assembly permits the remote locking and unlocking of the lid.

In still another aspect, the invention is an improvement to a vehicle having at least one door, a cargo container, and a remote door-locking system. The improvement includes a cargo-locking system for the cargo container. The cargo-locking system has a latch, an actuator and a locking member driven by the actuator. The locking member selectively engages and disengages the latch. The actuator operates in response to the remote door-locking system of the vehicle.

These and other aspects, features and advantages of the invention will be understood with reference to the drawing figures and detailed description herein, and will be realized by means of the various elements and combinations particularly pointed out in the appended claims. It is to be understood that both the foregoing general description and the following brief description of the drawings and detailed description of the invention are exemplary and explanatory of preferred embodiments of the invention, and are not restrictive of the invention, as claimed.

### BRIEF DESCRIPTION OF THE DRAWINGS

FIG. 1 is a perspective view of a vehicle-mounted container fitted with a locking system according to an example embodiment of the invention.

FIG. 2 is a front view of a remote locking assembly according to an example embodiment of the present invention, showing the locking assembly in the locked position.

FIG. 3 is a top view of the remote locking assembly of FIG. 2.

FIG. 4 is a front view of the remote locking assembly of FIG. 2, showing the locking assembly in the unlocked position.

FIG. 5 is a side view of the remote locking assembly of FIG. 2, with a portion of the actuator removed for clarity.

FIG. 6 is a front view of a toolbox fitted with the remote locking assembly of FIG. 2.

### DETAILED DESCRIPTION AND EXAMPLE EMBODIMENTS

The present invention may be understood more readily by reference to the following detailed description of the invention taken in connection with the accompanying drawing figures, which form a part of this disclosure. It is to be understood that this invention is not limited to the specific devices, methods, conditions or parameters described and/or shown herein, and that the terminology used herein is for the purpose of describing particular embodiments by way of example only and is not intended to be limiting of the claimed invention. Also, as used in the specification including the appended claims, the singular forms “a,” “an,” and “the” include the plural, and reference to a particular numerical value includes at least that particular value, unless the context clearly dictates otherwise. Ranges may be expressed herein as from “about” or “approximately” one particular value and/or to “about” or “approximately” another particular value. When such a range is expressed, another embodiment includes from the one particular value and/or to the other particular value. Similarly, when values are expressed as approximations, by use of the antecedent “about,” it will be understood that the particular value forms another embodiment.

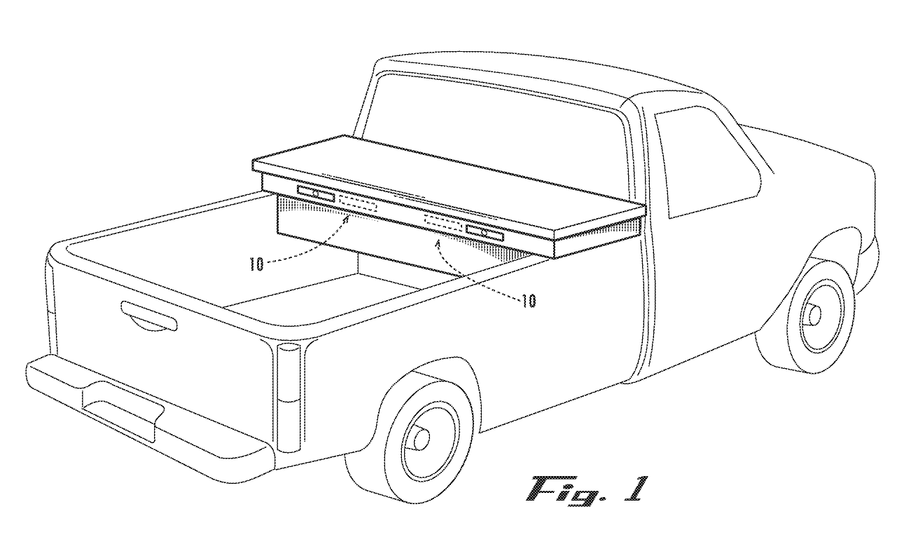

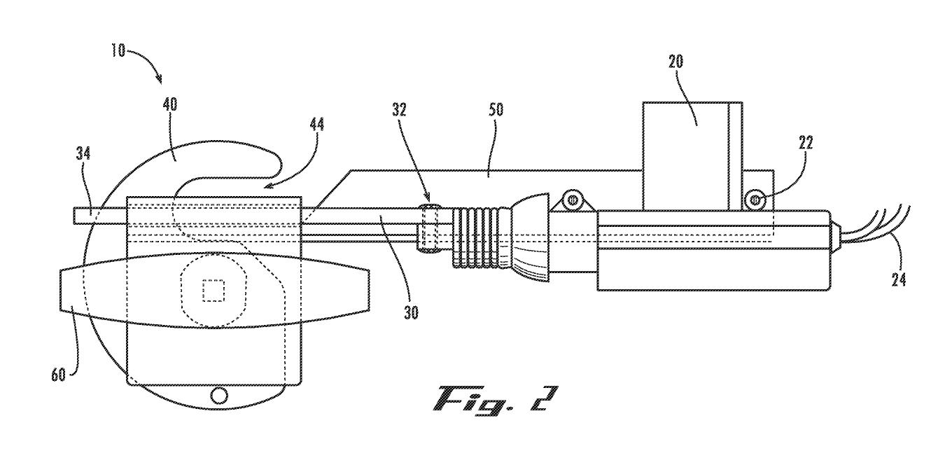

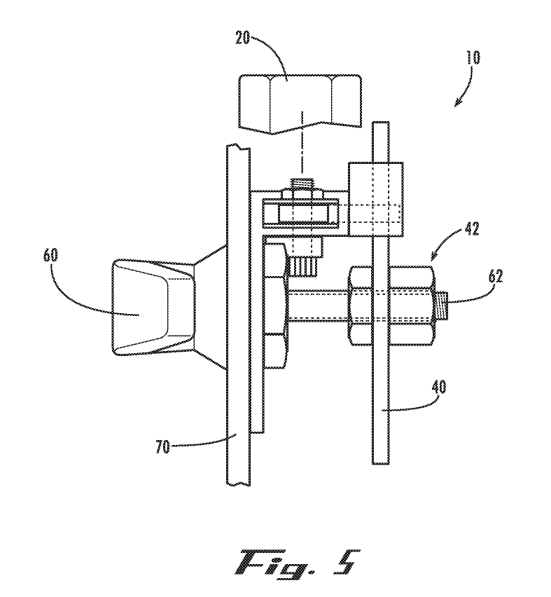

With reference now to the drawing figures, FIG. 1 shows a vehicle-mounted cargo container, and FIGS. 2-6 show a remote locking assembly 10 according to a first exemplary embodiment of the present invention. With reference to FIG. 2, the remote locking assembly 10 generally comprises an electronically controlled actuator 20, a locking member 30, a latching member 40, a support bracket 50, and optionally a handle 60. The remote locking assembly 10 of the present invention is suitable for use with, but not limited to, toolboxes and storage containers mounted within a cargo area of a vehicle. The remote locking assembly 10 can be integrated as original equipment within new toolboxes, or the existing latch and handle of a toolbox can be retrofitted with the remote locking assembly of the present invention.

In example embodiments, the remote locking assembly 10 is mounted to a vehicle cargo toolbox by securing the support bracket 50 to an interior wall 72 of the toolbox 70. The bracket 50 is preferably made of steel, aluminum, or other metals or substantially rigid materials or combinations thereof, and can be bolted, welded, glued, or otherwise fastened to the wall of the toolbox. Alternatively, the support bracket can comprise an integral part of the toolbox. An electronically controlled actuator 20 is preferably connected to the bracket 50. In the embodiment of FIG. 2, the electronically controlled actuator 20 is fastened to the bracket 50 with screws 22. In alternative embodiments, it can be appreciated that other fastening means can be employed including bolts, clips, glue, etc., or the actuator 20 can be integrally formed with the bracket 50.

The electronically controlled actuator 20 preferably comprises an electric motor, solenoid, piston or other actuation mechanism that is preferably connected to the vehicle's electrical system. The remote locking assembly 10 preferably includes wires 24 for connecting the assembly to the vehicle's electrical system for selectively operating the actuator 20. The actuator 20 is coupled to the locking member 30 and longitudinally extends and retracts the locking member as the actuator is operated in use. The actuator 20 is coupled to the locking member 30 with a bolt and nut coupling 32 in the depicted embodiment, but in alternate forms can be integrally formed or coupled by any other suitable connector or coupling means. In alternative embodiments, the actuator 20 is powered by an onboard power source such as a battery and is independent of the vehicle's electrical system.

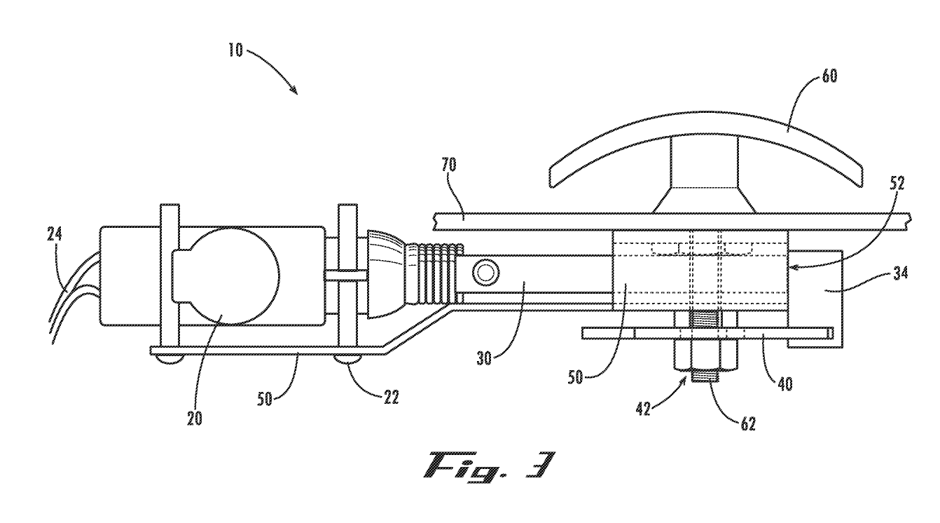

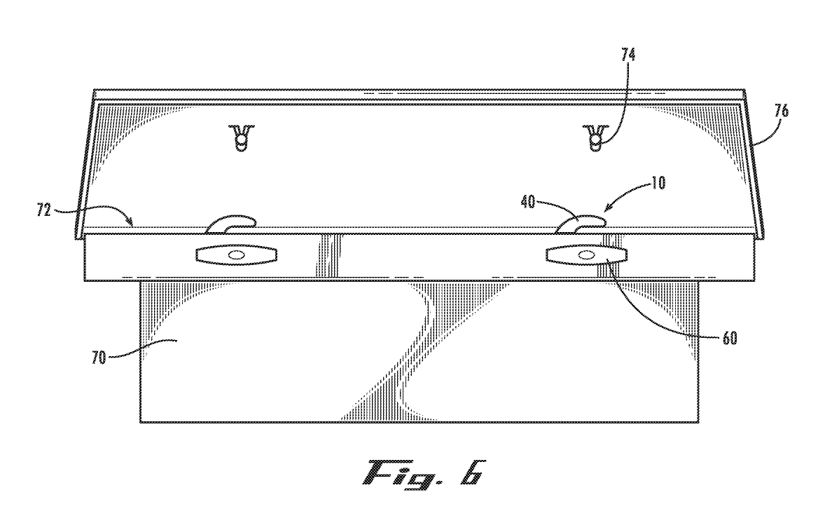

The handle 60 of the remote locking assembly 10 preferably extends through the well of the toolbox and is rotatably mounted to the exterior of the toolbox 70 as seen in FIGS. 3 and 6. A threaded bolt, stud, or other connector 62 extends axially from the handle 60 through the support bracket 50 towards the interior of the toolbox. The latching member 40 is preferably coupled to the connector 62 with a nut 42 or other fastener, whereby, when a user rotates the handle 60 the latching member 40 is also rotated accordingly. In example embodiments, the handle 60 is included as a component of the locking assembly 10. In alternative embodiments, the remote locking assembly 10 is configured for use in connection with a preexisting handle of the toolbox 70 such that the handle 60, is not included with the locking assembly of the present invention.

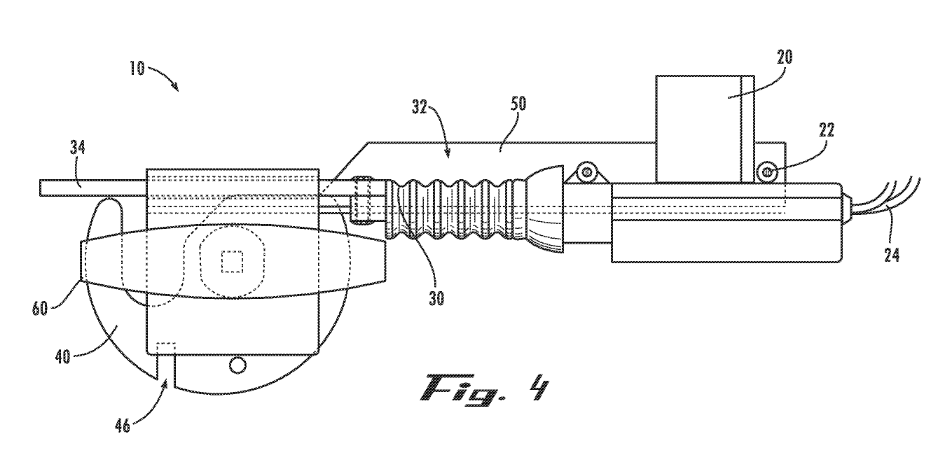

The latching member 40 preferably has a hooked latch receiver 44 for communicating with a complementary pin or protuberance of the toolbox 74 for securing and locking the toolbox lid 76 in the closed position. A user turns the handle 60, and subsequently the latching member 40, to release the latch 44 from engagement with the toolbox lid and thereby permit the user to raise the lid of the toolbox. Typically, the locking assembly 10 is mounted to the interior of the toolbox body, and the latch 44 engages and disengages a pin mounted to the interior of the toolbox lid. Alternatively, the remote locking assembly 10 is secured to the lid 76 of the toolbox, and the toolbox body 70 has the pin or protuberance 74 thereon for engagement and disengagement with the latch 44. The latching member 40 preferably also has a notch 46 formed therein for cooperating with the locking member 30. The notch 46 (see FIG. 4) is adapted to receive a flange or other interengaging portion 34 of the locking member therein to prevent the handle 60 and latching member 40 from rotating, and thus prohibiting the opening of the toolbox lid when the remote locking assembly is in the locked position as seen in FIG. 2. The latch 44 and the notch 46 are preferably oriented in opposite directions from one another along a chord of the generally circular latching member 40, and are preferably offset from one another by an offset angel of approximately 60 degrees. In other embodiments, the latch 44 and notch 46 can be oriented in the same direction and can be offset from one another by an angle of between 15 and 180 degrees. The handle 60 optionally has a secondary lock and key mechanism to externally lock the handle in place and prevent the handle from being rotated when the lock and key mechanism is in the lock position, even when the latching member 40 is not engaged by the locking member 30. By using a key, a user may unlock the secondary mechanism and thereby rotate the handle 60 when the locking member 30 is disengaged from the latching member 40.

The locking member 30, as seen in FIG. 3, is preferably L-shaped and extends horizontally from the actuator 20 through a channel 52 in the support bracket 50. As noted above, the locking member 30 is extended and retracted by the actuator 20 such that when the remote locking assembly is in the locked position, the flange 34 of the locking member is in engagement with the notch 46 of the latching member 40. Force exerted by the actuator 20 acting on the locking member 30 presses the flange 34 into engagement with the notch 46. Preferably, the notch 46 snugly engages the flange 34 when the remote locking assembly 10 is in the locked position to prevent unwanted loss of engagement between the same. In alternative embodiments, the orientation of the locking member 30 is reversed from that seen in FIG. 3 such that the flange 34 is directly coupled with, or proximal to the actuator 20 and whereby the flange is positioned between the actuator and the channel 52 of the bracket 50. Such embodiments are suitable for use with toolboxes 70 having side mounted open/close mechanisms, rather than the configuration shown in FIG. 1 which is configured for an open/close mechanism located on the back of the toolbox. The locking member 30 can be formed from a variety of materials including, but not limited to steel, aluminum, or other materials of sufficient strength and durability to prevent forced entry.

In operation a user can lock and unlock a toolbox in the cargo area of a vehicle to prevent others or allow access to the toolbox and its contents. In example embodiments, the remote locking assembly 10 is hardwired into the vehicle's electrical system, such that when a user locks and unlocks the doors of the vehicle either remotely or manually, the toolbox is automatically locked and unlocked as well. This can be accomplished by splicing the wiring of the remote locking assembly into the wiring of the vehicle's electrical door locking system, which is typically accessed within a door panel or in various other locations throughout the vehicle. When the user activates the vehicle's electronic locking system to lock the vehicle's doors, the vehicle's electrical system activates the actuator of the remote locking assembly 10 through the wires 24. The actuator 20 retracts the locking member 30, which retracts the flange 34 of the locking member into engagement with the notched recess 46 of the latching member 40 as seen in FIG. 2. With the latching member 40 snugly engaged by the locking member 30, a user can not rotate the handle 60 and thereby disengage the latching member from the corresponding pin or protuberance of the toolbox lid, thereby locking the toolbox. In alternative embodiments, the remote locking assembly can have an external power source, and/or it can be activated by an electrical signal other than the vehicle's door locking mechanism, such as from a separate remote transmitter dedicated to the toolbox locking assembly, or from a separate receiver coupled to the actuator 20.

The user preferably unlocks the toolbox by again activating the vehicle's door-locking system, which in turn operates the actuator 20 to extend the locking member 30, disengaging the flange 34 of the locking member from the notch 46 of the latching member 40. Once the flange 34 of the locking member 30 is released from engagement with the latching member 40, a user can rotate the handle 60 and open the lid of the toolbox as seen in FIG. 4. In alternative embodiments, the remote locking assembly 10 retracts the locking member 30 to reiease the locking member from engagement with the latching member 40 and extends the locking member to lock the toolbox. In still other embodiments, the handle 60 need not be rotated to open the toolbox, and/or can be omitted altogether, for example by combining the locking member and latching member so that sequential operation of the actuator engages and locks, then unlocks and disengages, the latch pin.

While the invention has been described with reference to preferred and example embodiments, it will be understood by those skilled in the art that a variety of modifications, additions and deletions are within the scope of the invention, as defined by the following claims.

1. A locking assembly for a vehicle-mounted toolbox having a body and a lid, said locking assembly comprising:
a latching member for selectively latching and releasing the toolbox lid and the toolbox body;
an electronically controlled actuator; and
a locking member movable between a first position and a second position by operation of the electronically controlled actuator, the locking member having a slot for receiving the latching member in its first position and disengaging the latching member in its second position.

2. The locking assembly of claim 1, wherein the latching member is rotationally mounted to the toolbox and rotatable between a latched position preventing opening of the lid, and a released position permitting opening of the lid.

3. The locking assembly of claim 2, further comprising a handle external of the toolbox for rotating the latching member between its latched and released positions.

4. The locking assembly of claim 2, wherein the locking member prevents rotation of the latching member from its latched position to its released position when the locking member is in its first position.

5. The locking assembly of claim 1, further comprising a support bracket for attachment to the toolbox.

6. The locking assembly of claim 5, wherein the locking member extends through a channel formed in the support bracket.

7. The locking assembly of claim 1, further comprising means for linking the electronically controlled actuator to operation of an electronic locking system of a vehicle.

8. The locking assembly of claim 7, wherein the means for linking comprises a wiring connection to the electronic locking system.

9. The locking assembly of claim 7, wherein the means for linking comprises a receiver for receiving a signal from a remote transmitter for operating the electronic locking system.

10. A storage container for mounting to a vehicle, said storage container comprising:
a container body enclosing a storage compartment and defining an opening for access to the storage compartment;
a lid for selectively covering and uncovering the opening to prevent and permit access to the storage compartment; and
a locking assembly permitting remote locking and unlocking of the lid, wherein the locking assembly comprises a latching member for selectively latching and releasing the lid and the container body, an electronically controlled actuator, and a locking member movable between a first position and a second position by operation of the electronically controlled actuator, the locking member having a slot for receiving the latching member in its first position and disengaging the latching member in its second position.

11. (canceled)

12. The storage container of claim 11, wherein the latching member is rotationally mounted to the container body and rotatable between a latched position preventing opening of the lid, and a released position permitting opening of the lid.

13. The storage containter of claim 12, further comprising a handle external of the body for rotating the latching member between its latched and released positions.

14. The storage containter of claim 12, wherein the locking member prevents rotation of the latching member from its latched position to its released position when the locking member is in its first position.

15. The storage container of claim 11, wherein the locking assembly further comprises a support bracket for attachment to the container body.

16. The storage container of claim 11, further comprising means for linking the electronically controlled actuator to operation of an electronic door-locking system of a vehicle.

17. The storage container of claim 16, wherein the means for linking comprises a wiring connection to the electronic door-locking system.

18. In a vehicle comprising at least one door, a cargo container having a lid and a body, and a remote door-locking system, the improvement comprising:
a cargo-locking system for the cargo container, said cargo-locking system comprising a latch, an actuator and a locking member driven by the actuator to selectively engage and disengage the latch, said actuator operable in response to the remote door-locking system of the vehicle.

19. The improvement of claim 18, wherein the latch is selectively maneuverable between a latched position securing the lid to the body, and a released position permitting opening of the lid.

20. The improvement of claim 19, wherein engagement of the locking member and the latch prevents the latch from being maneuvered to the released position.

21. The improvement of claim 18, further comprising a wiring connection for linking the actuator with the remote door-locking system of the vehicle.
